(19) United States
(12) Patent Application Publication
(10) Pub. No.: US 2013/0333826 A1
(43) Pub. Date: Dec. 19, 2013

(54) FORMING METHOD OF ANNULAR RUBBER MEMBER AND FORMING EQUIPMENT OF ANNULAR RUBBER MEMBER

(71) Applicant: TOYO TIRE & RUBBER CO., LTD., Osaka (JP)

(72) Inventor: Yusuke Kanamaru, Osaka-shi (JP)

(73) Assignee: TOYO TIRE & RUBBER CO., LTD., Osaka (JP)

(21) Appl. No.: 13/874,525

(22) Filed: May 1, 2013

(30) Foreign Application Priority Data
Jun. 19, 2012 (JP) 2012-137663

(51) Int. Cl. B29D 30/06

(52) U.S. Cl. CPC B29D 30/0681
USPC 156/123; 156/394.1

(57) ABSTRACT

A forming method of an annular rubber member comprises the step of forming a laminated body in which a plurality of layers overlap in a thickness direction, by continuously extruding a sheet-like rubber via a mouth piece provided in a leading end side of an extruder, and winding the extruded sheet-like rubber around a rotation support body. The layers having different widths are overlapped by changing an opening width of the mouth piece, at a time of changing from a stage of forming the layer which is positioned relatively at an inner peripheral side, to a stage of forming the layer which is positioned relatively at an outer peripheral side.

### BACKGROUND OF THE INVENTION

1. Field of the Invention

The present invention relates to a forming method of an annular rubber member, the method including a step of forming a laminated body by winding an extruded rubber around a rotation support body, and forming equipment which is used for the method.

2. Description of the Related Art

Conventionally, a tread rubber (one example of an annular rubber member) used for manufacturing a tire is formed by extruding a rubber via a mouth piece in which an opening is formed in correspondence to a cross sectional shape thereof, winding the rubber around a rotation support body so as to cut a length corresponding to a tire peripheral length, and jointing end portions with each other (for example, Paten Document 1). However, in this method, since it is necessary to prepare mouth pieces in correspondence to various sizes, productivity is lowered due to an increase of a setup work. In addition, there is a problem that a great step is formed in the joint portion due to an overlapping between the end portions, thereby deteriorating uniformity.

On the contrary, there has been known a method of extruding a narrow ribbon-like rubber so as to wind around a rotation support body, and forming an annular rubber member by a laminated body of the ribbon-like rubber (for example, Patent Document 2). According to this method, the kind of the mouth pieces and the work for the setup can be reduced, and the uniformity can be improved. However, in this method, since the ribbon-like rubber having a small cross section is wound several times over, there is a risk that a dispersion of a dimensional precision and an air mixing are generated. Further, since an opening of the mouth pieces is small, an internal pressure becomes higher, and there is a tendency that a load of the equipment is increased.

### PRIOR ART DOCUMENTS

Patent Document 1: Japanese Unexamined Patent Publication No. 06-071587

Patent Document 2: Japanese Unexamined Patent Publication No. 2002-178415

### SUMMARY OF THE INVENTION

The present invention is made by taking the actual condition mentioned above into consideration, and an object of the present invention is to provide a forming method of an annular rubber member and forming equipment of an annular rubber member which can lighten a load of the equipment while suppressing a dispersion of a dimensional precision and an air mixing by reducing a winding number.

The object can be achieved by the present invention having the following structure. The present invention provides a forming method of an annular rubber member, comprising the steps of forming a laminated body in which a plurality of layers overlap in a thickness direction, by continuously extruding a sheet-like rubber via a mouth piece which is provided in a leading end side of an extruder, and winding the extruded sheet-like rubber around a rotation support body, wherein the layers having different widths are overlapped in the thickness direction by changing an opening width of the mouth piece, at a time of changing from a stage of forming the layer which is positioned relatively at an inner peripheral side, to a stage of forming the layer which is positioned relatively at an outer peripheral side.

In this method, since the opening width of the mouth piece is changed in process of winding the sheet-like rubber, and the layers having the different widths are overlapped in the thickness direction, the method contributes to a formation of the annular rubber member which is constructed by the laminated body, for example, as shown in FIG. 5B. In addition, in comparison with the conventional method of winding the ribbon-like rubber, the winding number is reduced, and an outlet opening of the mouth piece becomes comparatively large. Accordingly, as well as it is possible to suppress the dispersion of the dimensional precision and the air mixing, the load of the equipment can be lightened without making the internal pressure higher.

In the forming method of an annular rubber member in accordance with the present invention, it is preferable that the layer positioned relatively at the outer peripheral side is formed narrower than the layer positioned relatively at the inner peripheral side, by narrowing the opening width of the mouth piece. Accordingly, it is possible to appropriately form the annular rubber member having the shape which is narrowed toward the outer peripheral side as exemplified in FIG. 5.

In forming method of an annular rubber member in accordance with the present invention, it is preferable that the layer positioned at the innermost peripheral side constructs a whole of an inner peripheral surface of the annular rubber member constructed by the laminated body, and the layer positioned at the outermost peripheral side constructs a whole of an outer peripheral surface of the annular rubber member constructed by the laminated body. In this case, since the cross section of the sheet-like rubber is suitably large, the winding number can be widely reduced, and the outlet opening of the mouth piece becomes larger. As a result, it is possible to well suppress the dispersion of the dimensional precision and the air mixing, thereby effectively lightening the load of the equipment.

In the forming method of an annular rubber member in accordance with the present invention, it is permissible that an opening end portion of the mouth piece is inclined with respect to the thickness direction, side surfaces of a plurality of layers constructing the laminated body are inclined, and a side surface of the laminated body is formed flat as a whole. Accordingly, it is possible to more precisely form the annular rubber member.

In the forming method of an annular rubber member in accordance with the present invention, it is preferable that the step of forming the laminated body comprises a stage of moving the mouth piece close to the rotation support body, starting winding after attaching a leading end portion of the extruded sheet-like rubber on the rotation support body, increasing a rubber extruding amount little by little while expanding a distance between the mouth piece and the rotation support body, thereafter winding the sheet-like rubber while keeping the distance, and forming the layer positioned at the innermost peripheral side, and a stage of finishing winding by reducing the rubber extruding amount little by little at an outer peripheral side of a winding start position, and forming the layer positioned at the outermost peripheral side.

According to the method mentioned above, it is possible to make the thickness of the rubber larger little by little at the winding start position of the sheet-like rubber, upon forming the layer positioned at the innermost side. In addition, it is possible to make the thickness of the rubber smaller little by little at the outer peripheral side of the winding start position, upon forming the layer positioned at the outermost peripheral side, where the winding end position is set. As a result, the thickness of the laminated body becomes uniform, and it is possible to precisely form the annular rubber member.

Further, the present invention provides forming equipment of an annular rubber member comprising an extruder which continuously feeds a rubber, a mouth piece which is provided in a leading end side of the extruder, a rotation support body around which the rubber extruded via the mouth piece is wound, and a control device which controls motions of the extruder and the rotation support body, wherein a sheet-like rubber is extruded via the mouth piece, and a laminated body having a plurality of layers overlapping in a thickness direction is formable by winding the sheet-like rubber around the rotation support body, wherein a motion of a movable piece embedded in the mouth piece is controlled by the control device, and an opening width of the mouth piece is changed in accordance with a displacement of the movable piece, and wherein the layers having different widths are controlled so as to be overlapped in the thickness direction by changing the opening width of the mouth piece, at a time of changing from a stage of forming the layer which is positioned relatively at an inner peripheral side, to a stage of forming the layer which is positioned relatively at an outer peripheral side.

In this equipment, since the opening width of the mouth piece is changed in process of winding the sheet-like rubber, and the layers having the different widths are overlapped in the thickness direction, the method contributes to a formation of the annular rubber member which is constructed by the laminated body, for example, as shown in FIG. 5B. In addition, in comparison with the conventional method of winding the ribbon-like rubber, the winding number is reduced, and an outlet opening of the mouth piece becomes comparatively large. Accordingly, as well as it is possible to suppress the dispersion of the dimensional precision and the air mixing, the load of the equipment can be lightened without making the internal pressure higher.

### BRIEF DESCRIPTION OF THE DRAWINGS

FIG. 1 is a schematic view showing an example of forming equipment of an annular rubber member;

FIG. 2 is a cross sectional view schematically showing a structure of an extruder;

FIG. 3 is a perspective view of a mouth piece;

FIG. 4 is a perspective view of a mouth piece from which an upper body is detached;

FIG. 5A is a cross sectional view of a tread rubber;

FIG. 5B is a cross sectional view of a laminated body which constructs the tread rubber;

FIG. 6A is a plan view showing a state in which a sheet-like rubber is wound;

FIG. 6B is a side view showing a state which a sheet-like rubber is wound;

FIG. 7A is a plan view showing a state in which a sheet-like rubber is wound;

FIG. 7B is a side view showing a state in which a sheet-like rubber is wound;

FIG. 8A is a plan view showing a state in which a sheet-like rubber is wound;

FIG. 8B is a side view showing a state in which a sheet-like rubber is wound;

FIG. 9A is a plan view showing a state in which a sheet-like rubber is wound;

FIG. 9B is a side view showing a state in which a sheet-like rubber is wound;

FIG. 10A is a plan view showing a state in which a sheet-like rubber is wound;

FIG. 10B is a side view showing a state in which a sheet-like rubber is wound;

FIG. 11A is a plan view showing a state in which a sheet-like rubber is wound;

FIG. 11B is a side view showing a state in which a sheet-like rubber is wound;

FIG. 12 is a cross sectional view along a circumferential direction of the tread rubber at a winding start position;

FIG. 13A is a perspective view of a movable piece in the other embodiment; and

FIG. 13B is a cross sectional view of a tread rubber in the other embodiment.

### DETAILED DESCRIPTION OF THE PREFERRED EMBODIMENTS

An embodiment of the present invention will be explained with reference to the drawings.

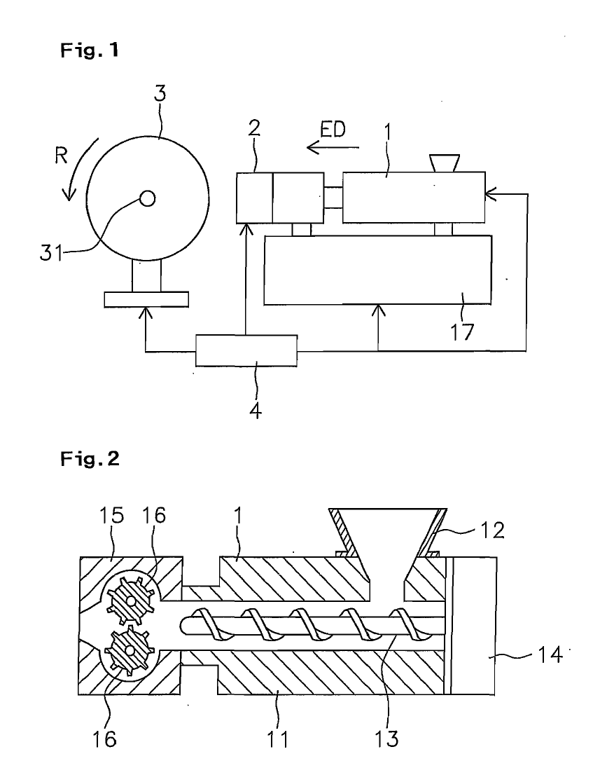

Forming equipment shown in FIG. 1 is provided with an extruder 1 which continuously feeds out a rubber, a mouth piece 2 which is arranged in a leading end side of the extruder 1, a rotation support body 3 around which the rubber extruded via the mouth piece 2 is wound, and a control device 4 which controls motions of the extruder 1 and the rotation support body 3. As shown in FIG. 2, the extruder 1 has a tubular barrel 11, a hopper 12 which is connected to a supply port of the barrel 11, a screw 13 which mixes the rubber so as to feed out to a leading end side, a motor 14 which rotationally drives the screw 13, and a gear pump 15 which serves as a fixed displacement pump for feeding the rubber to the mouth piece 2.

The gear pump 15 has a set of gears 16 which are rotationally driven by a motor (not shown). Rotating speeds of the screw 13 and the gear 16 are controlled in an interlocking manner by the control device 4 which mounts an inverter, and an unnecessary fluctuation of a rubber extruding amount can be suppressed. The gear pump 15 according to the present embodiment is an external pump which is attached to a leading end of the barrel 11, however, may be constructed by a built-in pump which is built in an internal portion of the barrel 11. In FIG. 2, as a matter of convenience for drawing, one set of gears 16 is drawn side by side vertically, however, is actually arranged in a plane direction (a direction in which a rotating axis of the gear 16 is a vertical direction in FIG. 2).

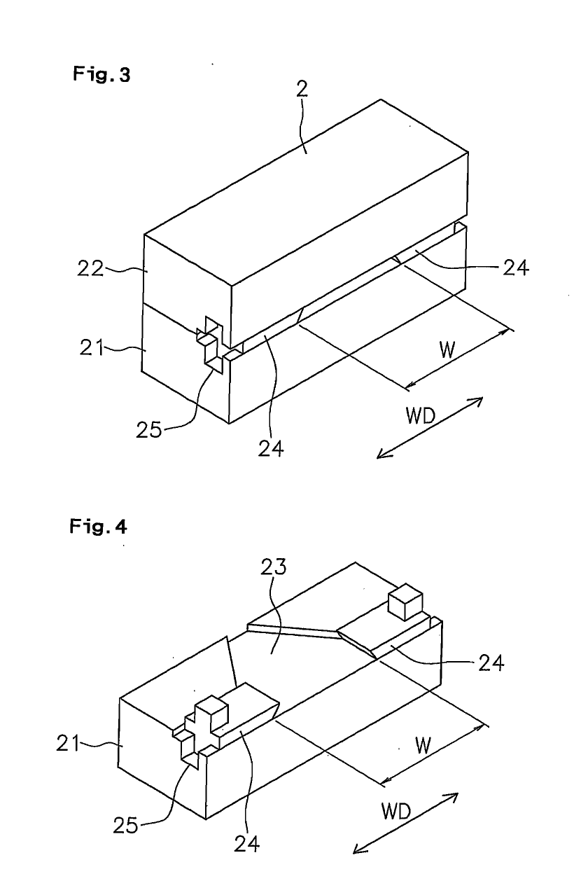

As shown in FIGS. 3 and 4, the mouth piece 2 has a lower body 21, and an upper body 22 which is mounted thereto, and a rubber flow path 23 is formed between the lower body 21 and the upper body 22. The rubber fed out of the extruder 1 via the gear pump 15 passes through a flat outlet opening via the rubber flow path 23, and is extruded as a sheet-like rubber having a width which corresponds to an opening width W. The mouth piece 2 has a pair of movable pieces 24 built-in, the movable pieces 24 being arranged in both sides in a width direction of the outlet opening, and is structured such that the opening width W can be changed in accordance with a displacement of the movable pieces 24 even in the course of the extrusion of the sheet-like rubber.

The movable pieces 24 are provided so as to displace in a width direction WD by a moving mechanism (not shown) which could be constructed by a feed screw and a motor, and a motion (specifically, moving direction, distance and speed) of the movable pieces 24 is controlled by the control device 4. Since the movable pieces 24 do not protrude out of a leading end surface of the mouth piece 2 and are flush with respect to the leading end surface in the present embodiment, the movable pieces 24 are convenient for moving the mouth piece 2 close to the rotation support body 3 as mentioned later. The movable pieces 24 are fitted to a guide groove 25 which extends in the width direction WD, and can be easily replaced by being detached even in a state in which the upper body 22 is mounted (refer to FIG. 3).

The rotation support body 3 is constructed by a forming drum which can rotate in an R direction around a shaft 31, and is provided with a motor (not shown) which rotationally drives the rotation support body 3. Further, the rotation support body 3 is structured such as to be relatively movable back and forth in an extruding direction ED against the extruder 1. In the present embodiment, there is shown an example in which the extruder 1 is moved by an extruder moving device 17, however, the extruder 1 may be moved close to or away from the rotation support body 3 by moving the rotation support body 3 in place of this structure or in addition to this structure. The movement of the extruder 1 and the rotating speed of the rotation support body 3 are controlled by the control device 4.

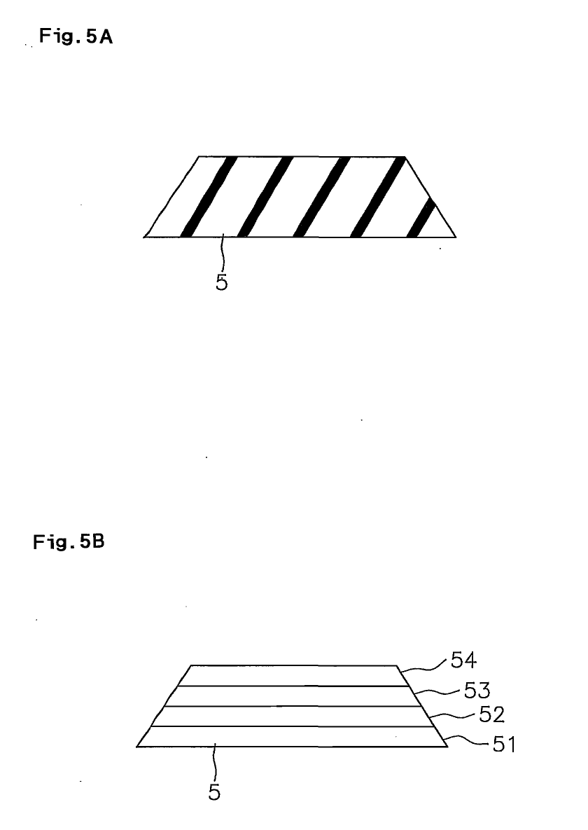

Next, a description will be given of a method of forming the annular rubber member by using the forming equipment mentioned above. In the present embodiment, there is shown an example in which the extruded sheet-like rubber is directly supplied to the rotation support body 3 so as to be wound, and the tread rubber 5 (an example of the annular rubber member) having a trapezoidal cross sectional shape is formed as shown in FIG. 5A. An annular rubber member formed by the present invention is not limited to the tread rubber, but can be applied to an annular rubber member which serves as the other tire constructing member, or an annular rubber member which is not the tire constructing member.

Although the details are described later, the method has a step of forming a laminated body structured such that a plurality of (four in the present embodiment) layers 51 to 54 overlap in a thickness direction as shown in FIG. 5B, by continuously extruding the sheet-like rubber via the mouth piece 2 which is provided at the leading end side of the extruder 1, and spirally winding the extruded sheet-like rubber around the rotation support body 3. The layers 51 to 54 are sequentially formed from an inner peripheral side (a lower side in FIG. 5) by winding one sheet-like rubber, and the tread rubber 5 is formed by the laminated body.

Further, in the step of forming the laminated body, the opening width W of the mouth piece 2 is changed at a time of changing from a stage of forming the layer which is positioned relatively at an inner peripheral side, to a stage of forming the layer which is positioned relatively at an outer peripheral side. In other words, the opening width W is changed by displacing the movable piece 24 at a time of changing from the stage of forming the layer 51 to the stage of forming the layer 52, changing from the stage of forming the layer 52 to the stage of forming the layer 53, and changing from the stage of forming the layer 53 to the stage of forming the layer 54. Accordingly, the layers having the different widths are overlapped in the thickness direction.

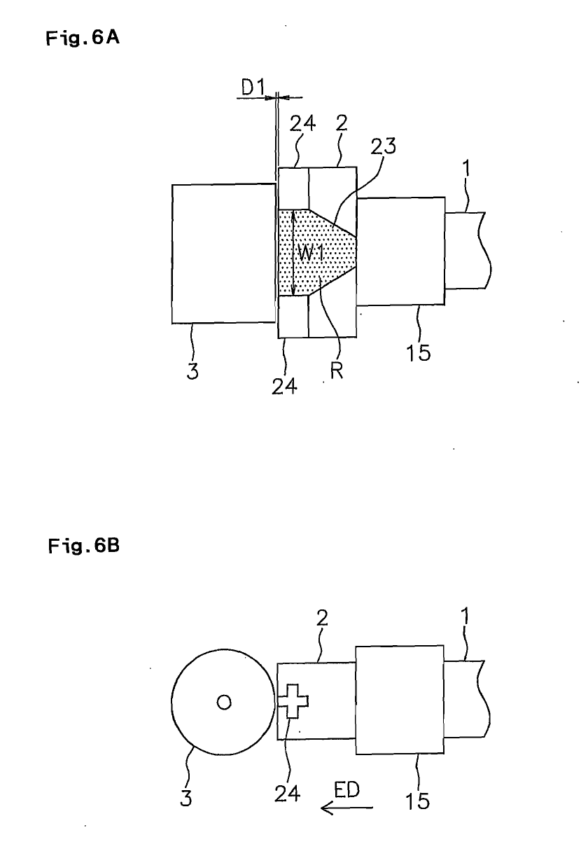

A description will be given below of a specific procedure of forming the tread rubber 5 with reference to FIGS. 6 to 11. In FIGS. 6 to 11, as a matter of convenience for description, the rubber flow path 23 and a pair of movable pieces 24 are drawn on the mouth piece in a plan view.

First of all, as shown in FIG. 6, the extruder 1 is moved forward in the extruding direction ED, and the mouth piece 2 is moved close to the rotation support body 3. A distance D1 between the mouth piece 2 and the rotation support body 3 is set so that a leading end portion of the extruded sheet-like rubber is attached on the rotation support body 3, and is preferably equal to or less than 0.1 mm. If the distance D1 is equal to or less than 0.1 mm, a thickness of the rubber at a time of starting the winding can be made equal to or less than 0.5 mm advantageously. The mouth piece 2 is moved close to the rotation support body 3 at such timing that the distance D1 is set before the rubber begins to be extruded from the outlet opening.

In this stage, a pair of movable pieces 24 are arranged comparatively at an outer side in the width direction, and the opening width W1 corresponding to the width of the layer 51 is set. The rubber R filled in the mouth piece 2 is obtained by mixing, by the screw 13, the rubber material thrown in the hopper 12, and feeding the mixed rubber material to the mouth piece 2 by the gear pump 15. As the rubber material, there can be exemplified a rubber material obtained by mixing a feed mixture with a general purpose rubber material such as a natural rubber, a styrene-butadiene rubber (SBR), a butadiene rubber (BR), an isoprene rubber (IR) or the like according to the usual manner and adjusting so that thermal cross-linking can be carried out.

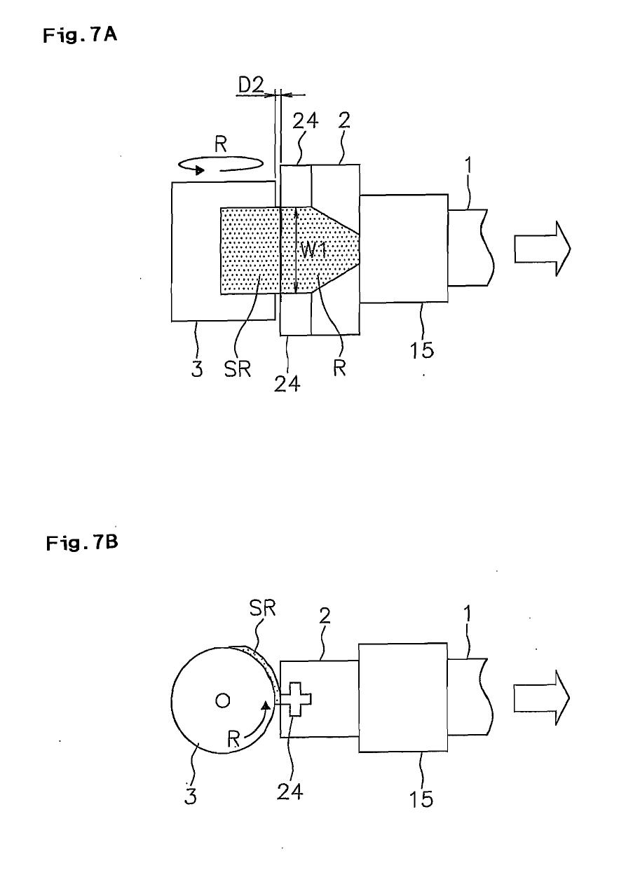

Subsequently, as shown in FIG. 7, the sheet-like SR is extruded from the mouth piece 2, and the rotation support body 3 is rotated so as to start winding after the leading end portion of the sheet like rubber SR is attached on an outer surface of the rotation support body 3. And, the extruder 1 is moved backward approximately at the same time of the rotation of the rotation support body 3, and a rubber extruding amount is increased little by little while expanding a distance between the mouth piece 2 and the rotation support body 3. The increase of the rubber extruding amount can be smoothly executed by controlling the rotating speed of the screw 13 and the gear 16. Thereafter, the sheet-like rubber SR is wound at a fixed thickness while keeping a distance D2, and the layer 51 positioned at the innermost peripheral side is formed.

As mentioned above, since the winding operation is started so that the sheet-like rubber SR is rubbed against the outer peripheral surface of the rotation support body 3, the thickness of the rubber at the winding start position can be enlarged little by little at a time of forming the layer 51. The distance D2 between the mouth piece 2 and the rotation support body 3 is larger than the distance D1, and is set to a dimension which corresponds to the thickness of the layer 51. The rubber extruding amount in the process of one turn of the rotation support body 3 is adjusted so that a volume of the layer 51 determined by a thickness, a width and a peripheral length of the sheet-like rubber SR can be obtained.

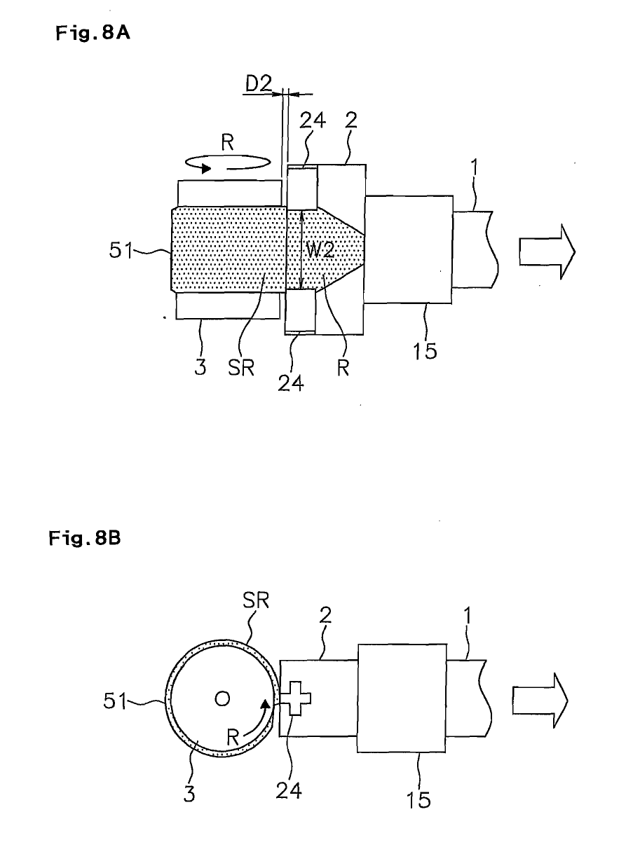

Next, when changing from the stage of forming the layer 51 which is positioned relatively at the inner peripheral side, to the stage of forming the layer 52 which is positioned relatively at the outer peripheral side, that is, when the rotation support body 3 turns one rotation as shown in FIG. 8 and the mouth piece 2 comes close to the winding start position, the opening width of the mouth piece 2 is narrowed by displacing a pair of movable pieces 24, and an opening width W2 corresponding to the width of the layer 52 is set. Accordingly, the layer 52 positioned relatively at the outer peripheral side is formed narrower than the layer 51 positioned relatively at the inner peripheral side.

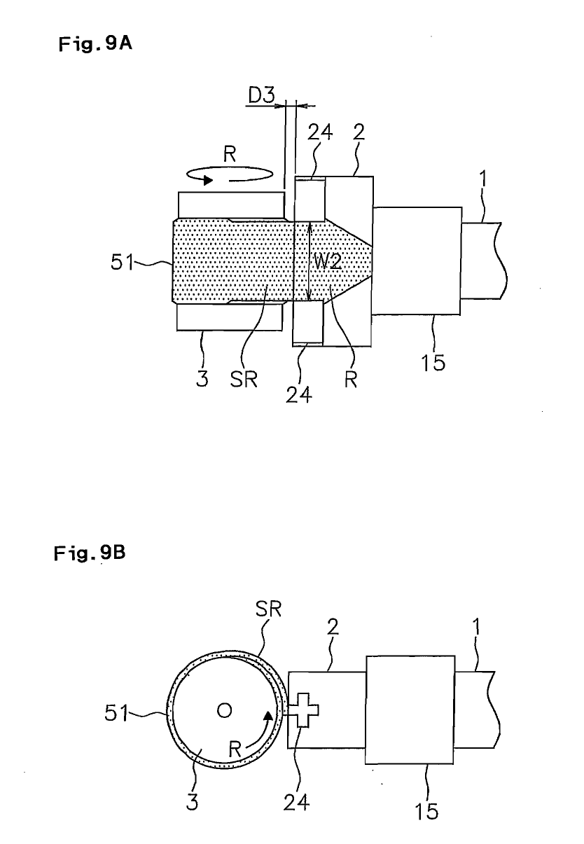

As shown in FIG. 9, when the layer 52 is formed by winding at the second rotation, the extruder 1 is moved further rearward at the outer peripheral side of the winding start position. A distance D3 between the mouth piece 2 and the rotation support body 3 is larger that the distance D2, and is set to a dimension which corresponds to a total thickness of the layers 51 and 52. Further, in the same manner as the winding at the first rotation, the rubber extruding amount in the process of one rotation of the rotation support body 3 is adjusted so that the volume of the layer 52 determined by the thickness, the width and the peripheral length of the sheet-like rubber SR can be obtained, in the winding at the second rotation.

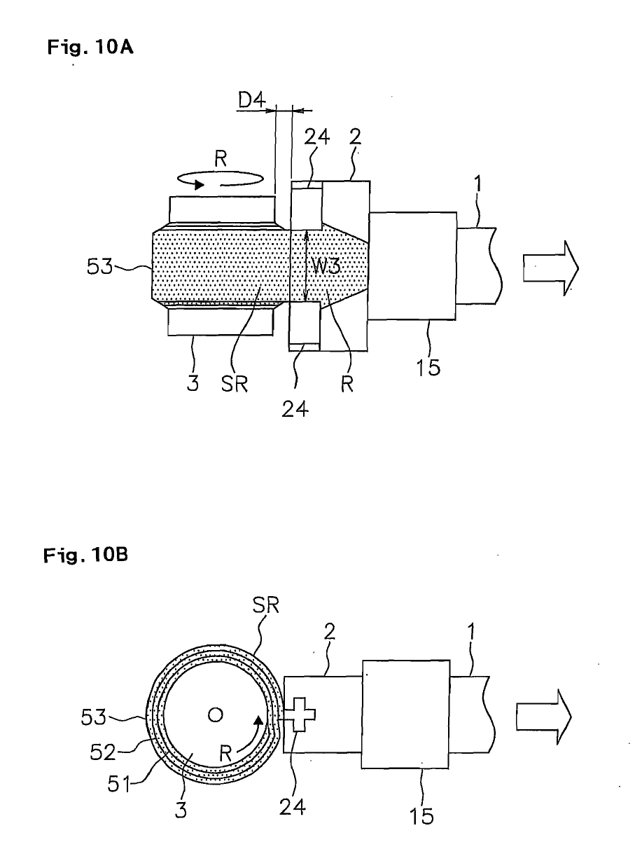

In the same manner as mentioned above, in the winding at a third rotation, the narrower layer 53 than the layer 52 is formed on an outer periphery of the layer 52, as shown in FIG. 10. An opening width W3 corresponding to a width of the layer 53 is set at the mouth piece 2. The opening width W3 is set by narrowing the opening width W2 at a time of changing from the stage of forming the layer 52 to the stage of forming the layer 53. A distance D4 between the mouth piece 2 and the rotation support body 3 is larger that the distance D3, and is set to a dimension which corresponds to a total thickness of the layers 51, 52 and 53.

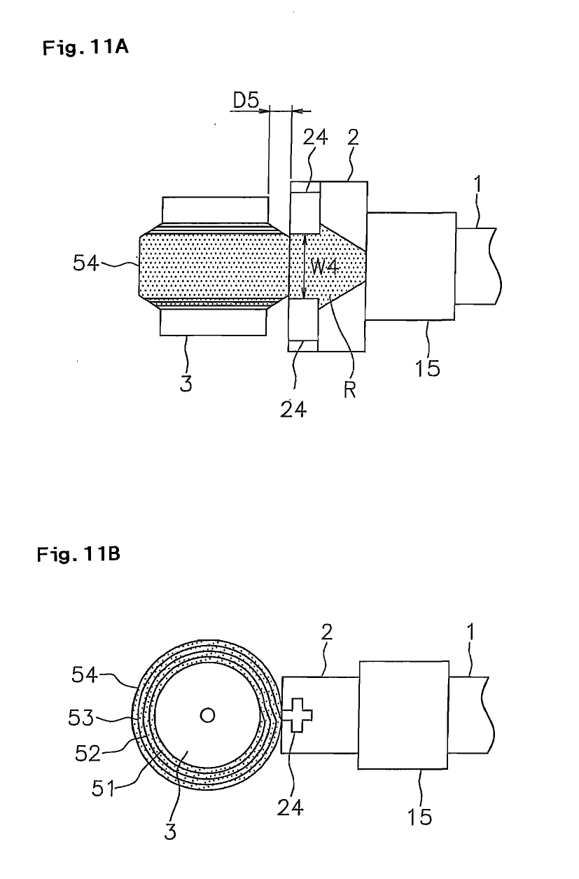

In the same manner as mentioned above, in the winding at a final fourth rotation, a narrower layer 54 than the layer 53 is formed on an outer periphery of the layer 53, as shown in FIG. 11. An opening width W4 corresponding to a width of the layer 54 is set at the mouth piece 2. The opening width W4 is set by narrowing the opening width W3 at a time of changing from the stage of forming the layer 53 to the stage of forming the layer 54. A distance D5 between the mouth piece 2 and the rotation support body 3 is larger than the distance D4, and is set to a dimension which corresponds to a total thickness of the layers 51, 52, 53 and 54.

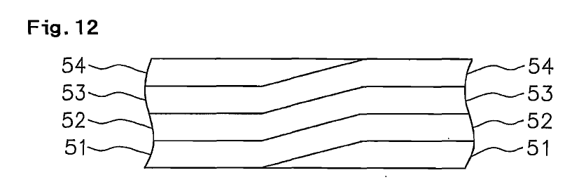

In the winding at the final rotation, the winding operation is finished by reducing the rubber extruding amount little by little at an outer peripheral side (a winding end position) of the winding start position, while maintaining the distance D5 between the mouth piece 2 and the rotation support body 3, whereby forming the layer 54 positioned at the outermost peripheral side. The reduction of the rubber extruding amount mentioned above can be smoothly executed by controlling the rotating speeds of the screw 13 and the gear 16. The thickness of the rubber at the winding end position can be made smaller little by little, at a time of forming the layer 54, by finishing the winding operation so that the sheet-like rubber SR is worn and torn, as mentioned above. As a result, the thickness of the laminated body is uniform as shown in FIG. 12, and an effect of improving uniformity and preventing the peeling can be obtained.

In the present embodiment, there is shown the example in which the distance D5 between the mouth piece 2 and the rotation support body 3 is maintained at the winding end position, in the winding at the final rotation, however, the mouth piece 2 may be lightly brought into contact with the laminated body by slightly moving the extruder 1 close to the rotation support body 3 just before finishing the winding operation of the sheet-like rubber SR.

When finishing the formation of the layers 51 to 54, the tread rubber 5 constructed by the laminated body is formed as shown in FIG. 5B. Thereafter, the mouth piece 2 is moved away from the rotation support body 3 by moving backward the extruder 1, and the formed tread rubber 5 is retrieved. And, the tread rubber 5 can be formed by moving the mouth piece 2 close to the rotation support body 3 in which the outer surface is exposed, or close to the other rotation support body, so shown in FIG. 6.

In the present embodiment, the leading end shape of the movable piece 24 is set diagonally as shown in FIGS. 3 and 4, and the opening end portion of the mouth piece 2 is inclined with respect to the thickness direction. Therefore, the outlet opening is formed as the trapezoidal shape, and side surfaces of a plurality of layers 51 to 54 constructing the laminated body are inclined. Further, the layers 51 to 54 are overlapped so that side surfaces are aligned, for obtaining the cross sectional shape as shown in FIG. 5B. As a result, the side surface of the laminated body is formed flat as a whole.

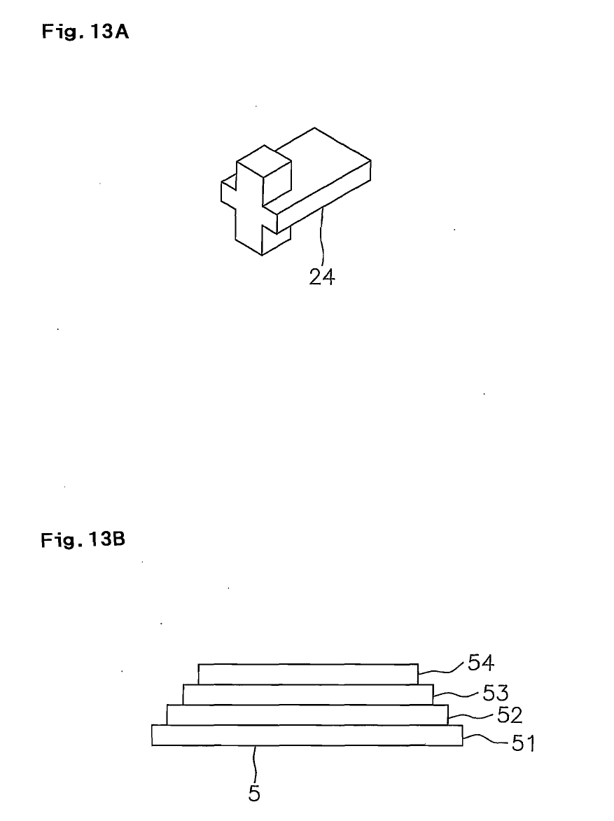

On the other hand, the leading end shapes of the movable pieces 24 may be parallel in the thickness direction as shown in FIG. 13A. In this case, since the outlet opening of the mouth piece 2 is formed as a rectangular shape, and the sheet-like rubber is extruded with a cross sectional shape corresponding thereto, the laminated body is formed with a shape shown in FIG. 13B. The leading end shapes of a pair of movable pieces 24 may be different from each other, for example, one of them may be inclined with respect to the thickness direction (refer to FIGS. 3 and 4), and the other may be parallel to the thickness direction (refer to FIG. 13).

In the present embodiment, both of a pair of movable pieces 24 are displaced for changing the opening width of the mouth piece 2, however, only one of them may be displaced. The movable piece may be provided only in one side in the width direction of the outlet opening of the mouth piece 2, and may be omitted at the other side. Accordingly, for example, in the laminated body shown in FIG. 5, the side surfaces in one side may be parallel in the thickness direction. Further, in the present embodiment, there is shown the example in which the annular rubber member is finished by one laminated body, however, the annular rubber member may be formed by a plurality of laminated bodies which are connected in the width direction.

The sheet-like rubber SR extruded via the mouth piece 2 is larger in the thickness than in the width. The width of the sheet-like rubber SR is set, for example, equal to or more than fiftyfold the thickness, in the stage of forming the layer 51 which is positioned in the innermost peripheral side. The thickness of the sheet-like rubber is set, for example, to 1 to 3 mm. For precisely forming the annular rubber member, the number of the layers constructing the laminated body is preferable equal to or more than 3, and more preferable equal to or more than 4.

In the present embodiment, there is shown the example in which the opening width of the mouth piece 2 is changed per rotation, however, a portion where the sheet-like rubber is wound at plural rotations without changing the opening width of the mouth piece may be included in accordance with the cross sectional shape of the laminated body or the thickness of the sheet-like rubber, without being limited to this example. Further, in the present embodiment, there is shown the example in which both ends of the layer positioned relatively at the outer peripheral side are arranged between both ends of the layer positioned at the inner peripheral side thereof, however, the structure is not limited to this.

In the present embodiment, the layer 51 positioned at the innermost peripheral side constructs a whole of the inner peripheral surface of the tread rubber 5 constructed by the laminated body, and the layer 54 positioned at the outermost peripheral side constructs a whole of the outer peripheral surface of the tread rubber 5 constructed by the laminated body. The tread rubber 5 is formed as a shape which is narrowed toward the outer peripheral side, and the width of the layer 51 corresponds to the width of the tread rubber 5. In the present embodiment, in the bottom surface of the tread rubber 5, the layer 51 positioned at the innermost peripheral side occupies 100% of the width of the tread rubber 5, and the rate is preferably at least 50%.

The embodiment mentioned above is structured such as to start winding the sheet-like rubber while moving the mouth piece close to the rotation support body, and the mouth piece is thereafter moved away little by little, however, the winding operation may be started in a state in which the mouth piece is away from the rotation support body from the beginning. In this case, it is preferable that a pressure application roller for pressing the sheet-like rubber toward the rotation support body is provided.

In the embodiment mentioned above, there is shown the example in which the laminated body is formed without relatively moving the rotation support body in the axial direction with respect to the extruder, however, a laminated body having a desired cross sectional shape may be obtained by relatively moving the ration support body in the axial direction in the process of winding the sheet-like rubber, as occasion demands. In order to make the mechanism and the control of the device simple, it is preferable that the relative movement in the axial direction of the rotation support body is not carried out such as the embodiment mentioned above.

What is claimed is:

1. A forming method of an annular rubber member, comprising the steps of:
forming a laminated body in which a plurality of layers overlap in a thickness direction, by continuously extruding a sheet-like rubber via a mouth piece which is provided in a leading end side of an extruder, and winding the extruded sheet-like rubber around a rotation support body,
wherein layers having different widths are overlapped in the thickness direction by changing an opening width of the mouth piece, at a time of changing from a stage of forming the layer which is positioned relatively at an inner peripheral side, to a stage of forming the layer which is positioned relatively at an outer peripheral side.

2. The forming method of the annular rubber member according to claim 1, wherein the layer positioned relatively at the outer peripheral side is formed narrower than the layer positioned relatively at the inner peripheral side, by narrowing the opening width of the mouth piece.

3. The forming method of the annular rubber member according to claim 1, wherein the layer positioned at the innermost peripheral side constructs a whole of an inner peripheral surface of the annular rubber member constructed by the laminated body, and the layer positioned at the outermost peripheral side constructs a whole of an outer peripheral surface of the annular rubber member constructed by the laminated body.

4. The forming method of the annular rubber member according to claim 1, wherein an opening end portion of the mouth piece is inclined with respect to the thickness direction, side surfaces of a plurality of layers constructing the laminated body are inclined, and a side surface of the laminated body is formed flat as a whole.

5. The forming method of the annular rubber member according to claim 1, wherein the step of forming the laminated body comprises:
a stage of moving the mouth piece close to the rotation support body, starting winding after attaching a leading end portion of the extruded sheet-like rubber on the rotation support body, increasing a rubber extruding amount little by little while expanding a distance between the mouth piece and the rotation support body, thereafter winding the sheet-like rubber while keeping the distance, and forming the layer positioned at the innermost peripheral side; and
a stage of finishing winding by reducing the rubber extruding amount little by little at an outer peripheral side of a winding start position, and forming the layer positioned at the outermost peripheral side.

6. Forming equipment of an annular rubber member comprising:
an extruder which continuously feeds a rubber;
a mouth piece which is provided in a leading end side of the extruder;
a rotation support body around which the rubber extruded via the mouth piece is wound; and
a control device which controls motions of the extruder and the rotation support body,
wherein a sheet-like rubber is extruded via the mouth piece, and a laminated body having a plurality of layers overlapping in a thickness direction is formable by winding the sheet-like rubber around the rotation support body,
wherein a motion of a movable piece embedded in the mouth piece is controlled by the control device, and an opening width of the mouth piece is changed in accordance with a displacement of the movable piece, and
wherein the layers having different widths are controlled so as to be overlapped in the thickness direction by changing the opening width of the mouth piece, at a time of changing from a staged for forming the layer which is positioned relatively at an inner peripheral side, to a stage of forming the layer which is positioned relatively at an outer peripheral side.

7. The forming equipment of an annular rubber member according to claim 6, wherein an opening end portion of the mouth piece is inclined with respect to the thickness direction.
